(19) United States
(12) Patent Application Publication
(10) Pub. No.: US 2006/0233112 A1
(43) Pub. Date: Oct. 19, 2006

(54) Controllable frequency divider circuit, transmitter/receiver with a controllable frequency divider circuit, and a method for carrying out a loop-back test

(76) Inventor: Frank Demmerle, Augsburg (DE)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 11/387,338

(22) Filed: Mar. 23, 2006

(30) Foreign Application Priority Data
Mar. 23, 2005 (DE) DE102005013497.1

(51) Int. Cl. H04J 3/14

(52) U.S. Cl. 370/249

(57) ABSTRACT

A frequency divider circuit can be utilized for loop-back tests in a transmitter/receiver. In one embodiment, provision is made for a multiplexer to be connected downstream from a frequency divider, whose output side produces signal elements with different phases. The multiplexer is designed to periodically switch its inputs to its output by means of a control signal at its control input. The periodicity of the switching results in a frequency offset with respect to an unswitched signal, by which means a test signal is produced with a difference frequency during frequency conversion. Other systems and methods are also disclosed.

REFERENCE TO RELATED APPLICATIONS

This application claims the benefit of the priority date of German application DE 10 2005 013 497.1, filed on Mar. 23, 2005, the contents of which are herein incorporated by reference in their entirety.

### FIELD OF THE INVENTION

The present invention relates to a controllable frequency divider circuit and to a transmitter/receiver having such a frequency divider circuit. More particularly, the invention relates to a method for carrying out a loop-back test.

### BACKGROUND OF THE INVENTION

Modern communication systems, in particular transmitter/receivers, are frequently formed by large-scale-integrated circuits in a semiconductor body. In this case, the integrated circuits are subject to different functional tests in various production phases. Simple functional tests allow faults that have occurred during a production step to be located precisely, and appropriate countermeasures to be taken.

One test that is frequently carried out is the so-called loop-back test. This is often used to check simple functionality of a transmitting path and/or a receiving path in an integrated circuit. For example, the test can be used to determine whether an amplifier stage in a reception path or transmission path of the transmitter/receiver is damaged. The loop-back test is also suitable for functional testing of the integrated circuit at a time at which the semiconductor body that includes the circuit is still part of a wafer, and has not yet been implemented in a chip package.

During a loop-back test, a radio-frequency signal is produced in the transmission path, and is supplied directly to the reception path. The reception path uses a mixer to convert this signal to a baseband signal, and emits this at its output. When there is a frequency offset between the transmission signal and a local oscillator signal in the reception path, a signal is produced at a heterodyne frequency at the output of the receiver, whose amplitude and phase can be measured and allow deduction of possible production faults in the reception path and/or transmission path.

Modern radio-frequency components with an integrated transmitter/receiver typically have one jointly used circuit for frequency production. Thus, a local oscillator frequency is at the same time the frequency of the transmission signal. This leads during frequency conversion in the reception path to there being no low-frequency difference signal and, instead, only a DC voltage can be tapped off at the output of the receiver. No specific statements can be obtained during a functional test such as this because the phase relationships are normally difficult to determine in advance. Stable and reproducible measurements are extremely difficult.

### SUMMARY OF THE INVENTION

The following presents a simplified summary of the invention in order to provide a basic understanding of some aspects of the invention. This summary is not an extensive overview of the invention, and is neither intended to identify key or critical elements of the invention nor to delineate the scope of the invention. Rather, the purpose of the summary is to present some concepts of the invention in a simplified form as a prelude to the more detailed description that is presented later.

A digital frequency divider circuit comprises a signal input for supplying a preferably digital clock signal, as well as a signal output. A first flipflop circuit as well as at least one second flipflop circuit are connected by a clock input to the signal input of the controllable frequency divider circuit. The two flipflop circuits each have a data input, a first data output, and a second data output. An output signal can be tapped off at the data output. An output signal which is inverted with respect to the output signal from the first data output can in each case be tapped off at the second data output. The data input of the at least one second flipflop circuit is connected to the first data output of the first flipflop circuit, and the second data output of the second flipflop circuit is connected to the data input of the first flipflop circuit, forming a feedback path. The controllable frequency divider circuit according to the proposed principle accordingly comprises a frequency divider which divides the frequency of a signal which is supplied to its signal input by one factor, and produces frequency-divided signals, which each have different phases, at a plurality of data outputs. The data outputs of the frequency divider and/or of the first and second flipflop circuits are connected to the signal inputs of a multiplexer. The multiplexer furthermore comprises a data output as well as a signal input, and is designed to periodically pass on one of its signal inputs to the signal output, with the period being dependent on the frequency of a control signal which is supplied to the control input.

Various embodiments can make use of the fact that digital frequency divider circuits, preferably in the form of flipflop circuits, not only divide the frequency of a signal supplied to them but also produce signal elements at different phase angles. The multiplexer which is connected downstream from a frequency divider such as this allows periodic switching between these phase-shifted signal elements. The switching corresponds to phase and/or frequency modulation of the original frequency-divided signal, with the switching period determining the frequency offset with respect to the frequency of the original signal.

In one embodiment, the controllable frequency divider circuit includes an additional frequency divider, whose output side is connected to the control input of the multiplexer, and whose input side is connected to the signal input of the frequency divider circuit. The further frequency divider results in the control signal for the periodic switching of the phase-shifted signals being produced from the clock signal which is supplied to the frequency divider circuit. This advantageously ensures a certain amount of synchronicity, and improves the spectral quality of the output signal from the frequency divider circuit.

In one embodiment, the frequency divider includes a set input for setting a division ratio. The frequency divider is in the form of a sigma-delta divider so that different division ratios can be set by supplying a set signal to the divider. This makes it possible to produce a flexibly selectable frequency offset with respect to the one signal with the divided frequency. In another embodiment, it includes two series-connected flipflop circuits, which are connected in such a way that they form a frequency divider.

In one embodiment, the multiplexer comprises a logic OR gate, whose output at the same time also forms the signal output of the multiplexer, and whose input side is connected to an output of at least one logic AND gate. A first input of the logic AND gate is coupled to one of the at least four signal inputs of the multiplexer. A signal which is derived from a signal that is applied to the control input of the multiplexer can be supplied to the second input of the logic AND gate.

A transmitter/receiver having the controllable frequency divider circuit contains a transmission path with an input as well as an amplifier circuit, which is connected to the input. A reception path with a reception amplifier circuit is connected to one output of the transmission path. The reception path comprises a demodulator for frequency conversion, which has a local oscillator input and one output. On the input side, the demodulator is coupled to the reception amplifier circuit, for frequency conversion. A phase locked loop in the transmitter/receiver with an output for a carrier signal is connected to the signal input of the controllable frequency divider circuit. Finally, the transmitter/receiver comprises a switch with a first input as well as a second input and an output which is connected to the input of the transmission path. The switch is designed for selective coupling of one input to its output, with the first input of the switch being connected to the signal output of the controllable frequency divider circuit, and with the second input of the switch being connected to the output of the phase locked loop.

This embodiment makes it possible for the transmitter/receiver to switch between a normal mode and a test mode by means of the switch. In the normal mode, the transmission path is connected to the output of the phase locked loop directly or alternatively via a frequency divider with a fixed or variable division factor, for example in order to supply a phase-modulated signal. In the test mode, it is coupled to the output of the frequency divider circuit, which supplies a signal with a frequency offset to the transmission path on the basis of the periodic switching between the various phase angles of the frequency-divided signal. The frequency offset corresponds to the duration of a complete switching process through all of the phase states.

In one embodiment of the invention, the switch output is connected to the local oscillator input of the demodulator for frequency conversion. The input of the transmission path is coupled directly or via a frequency divider to the output of the phase locked loop.

In another embodiment, the local oscillator input of the demodulator is coupled to the output of the phase locked loop, for frequency conversion in the reception path. The signals for the reception path and the transmission path are thus produced by one phase locked loop for frequency preprocessing. The additional controllable frequency divider circuit that is provided produces an additional frequency offset, and thus allows a loop-back test to be carried out on the transmitter/receiver.

In one embodiment, a control circuit is provided, and is connected to a set input of the phase locked loop, to the first switch and to a second switch. The second switch is used for coupling the transmission path to the reception path. The control circuit is designed to emit control signals for a loop-back test. This includes, inter alia, the output of the transmission path being coupled to the input of the reception path. At the same time, the control circuit ensures that the output of the controllable frequency divider circuit is passed on to the output of the first switch. In addition, the set input of the phase locked loop is not supplied with an undesirable phase modulation word which changes the frequency of the output signal from the control loop and can corrupt a possible loop-back test.

In various embodiments, a transmission path and a reception path with a frequency converter are provided for a loop-back test. The transmission path is coupled to the reception path, and a carrier signal at one frequency is then produced. In this case, provision is made for the carrier signal to be used both for the transmission path and for the reception path. The frequency of the carrier signal is divided, and is used to produce a frequency-divided signal. Furthermore, at least four signal elements are produced at the divided frequency and each with a different phase. One of the at least four signal elements is then periodically selected. The respectively selected signal is supplied to a transmission path. A signal which contains a frequency offset is thus supplied to the transmission path by the periodic selection of one of the at least four signal elements. The frequency offset is produced on the basis of the sudden phase change between the at least four signal elements. At the same time, a signal at the frequency of the at least four signal elements is supplied as a local oscillator signal to the reception path. The signal which is emitted from the transmission path is fed back to the reception path, and its frequency is converted by means of the local oscillator signal. The frequency offset resulting from the periodic selection results in a signal being produced at the output of the reception path with the difference frequency which results from the period clock in time with the periodic selection. An amplitude of this difference frequency is finally determined.

The method may make use of the fact that a plurality of signal elements at a divided frequency and with a different phase angle are frequently produced on division of a signal. The periodic switching between the individual phase-shifted signals results in frequency modulation with respect to the divided signal. During the subsequent processing in the reception path, the frequency offset signal in the transmission path is converted again. A signal at the difference frequency can be tapped off at the output of the reception path. This difference frequency results from the frequency of the periodicity of the switching process. In other words, the frequency offset corresponds to the duration of the periodic switching through all of the phase states.

In this case, the difference frequency can be produced both by periodic switching of one of the at least four signal elements and supplying the selected signal to the transmission path. The signal which is emitted from the transmission path is then converted in the reception path again with the aid of one of the at least four signal elements. Alternatively, it is possible to provide for a signal to be supplied to the transmission path at the frequency of the at least four signal elements, and for the respectively selected signal to be emitted as a local oscillator signal to the reception path. In consequence, the local oscillator signal contains a frequency offset.

The phase offset between the individual signal elements may be dependent on the frequency division. For example, when the frequency is divided by a factor of 2, a total of four signal elements can preferably be produced, with a phase offset of in each case 90° between them. For example, if the frequency is divided by a factor of 4, signal elements are produced which have a phase offset of 45°, or of a multiple of this, between them.

### BRIEF DESCRIPTION OF THE DRAWINGS

The invention will be explained in the following text using illustrated embodiments and with reference to the drawings, in which:

FIG. 1 shows one embodiment of the frequency divider circuit,

FIG. 2 shows one embodiment of the frequency divider circuit,

FIG. 3 shows one embodiment of the frequency divider circuit,

FIG. 4A shows one embodiment of a transmitter/receiver,

FIG. 4B shows one embodiment of the transmitter/receiver,

FIG. 5 shows a time/signal diagram that relates to the method of operation of the frequency divider circuit shown in FIG. 3,

FIGS. 6A and 6B show a spectrum with an unmodulated and a modulated carrier signal, respectively and

FIG. 7 shows one embodiment of the method.

### DETAILED DESCRIPTION OF THE INVENTION

The present invention will now be described with reference to the drawings wherein like reference numerals are used to refer to like elements throughout, and wherein the illustrated structures are not necessarily drawn to scale.

A loop-back test in the case of integrated circuits for transmitters/receivers can be implemented by providing either two separate circuits for frequency production for the transmission path and for the reception path, or by providing an additional modulator in the transmission path, via which a frequency offset can likewise be produced in the transmission signal.

However, some integrated circuits with transmitters/receivers do not use an additional modulator, for example an I/Q modulator. Rather these integrated circuits directly produce a phase-modulated signal in a phase locked loop in the transmitter/receiver. The phase locked loop is also used for production of the local oscillator signal in the reception path, so that the problem mentioned above occurs during a loop-back test. Subsequent integration of a second circuit for frequency preprocessing or of an I/Q modulator for test purposes leads, however, to additional costs and to a larger chip area.

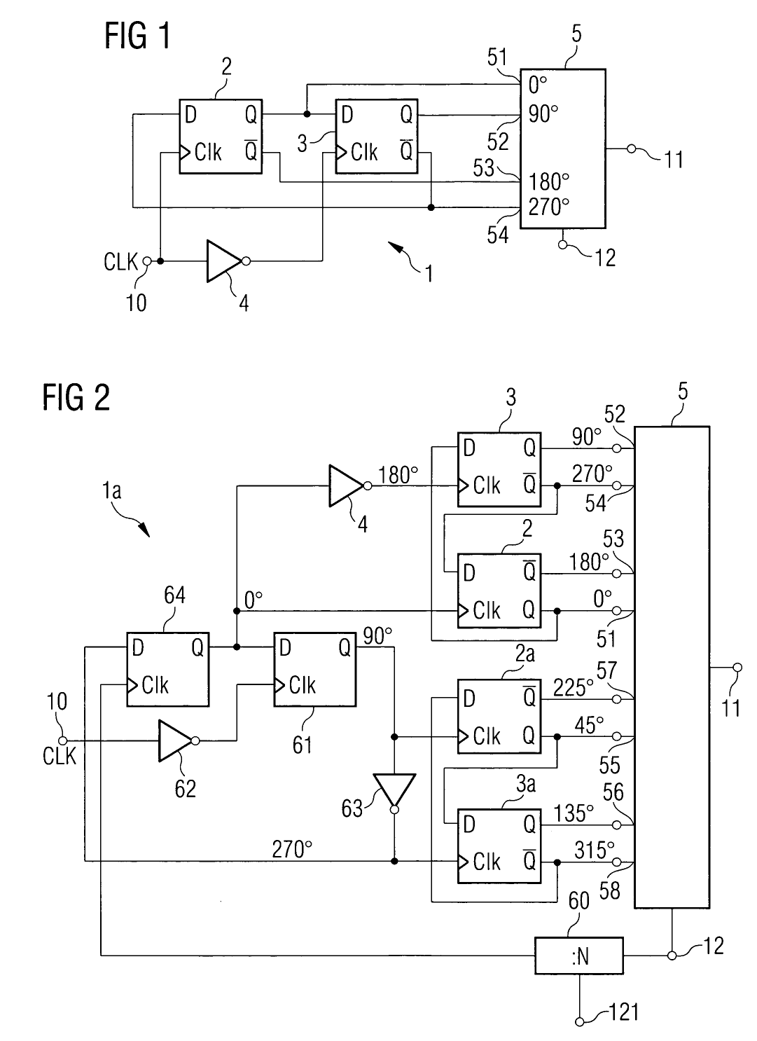

FIG. 1 shows one frequency divider circuit for production of a frequency offset for a frequency-divided clock signal. The clock signal CLK is in this case supplied to a signal input 10 of the frequency divider circuit 1. The frequency divider circuit 1 comprises two flipflop circuits 2 and 3, which are also referred to as bistable multivibrator circuits. Each flipflop circuit has a clock signal input Clk, a data input D as well as a data output Q and \overline{Q}. The signals which can be tapped off at the data outputs Q and \overline{Q} are inverted with respect to one another.

A flipflop circuit of the stated type emits a signal, which is applied to its data input D, with each rising clock flank of the clock signal CLK at the clock signal input Clk, at the data output Q. At the same time, an output signal which is inverted with respect to this output signal is emitted at the data output \overline{Q}. Although the illustrated embodiments show D-type flipflops, the present invention contemplates the use of these and other flipflops as well as other memory storage units, including but not limited to: JK flipflops , SR flipflops, T-flipflops, edge-triggered flipflops, and master-slave flipflops.

The clock signal input 10 is connected to the clock input Clk of the first flipflop 2 (which may also be referred to as the front-end flipflop), and is connected via an inverter 4 to the clock signal input CLK of the second flipflop 3 (which may also be referred to as the intermediate flipflop. The data output Q of the first flipflop is connected to the data input D of the second flipflop. The data output \overline{Q} for an inverted output signal from the second flipflop is connected, forming a feedback path, to the data input D of the first flipflop. Signals which are at the same frequency but have a phase offset of 90° with respect to one another can accordingly be tapped off at the data outputs Q and \overline{Q} of the two flipflop circuits. The data outputs of the two flipflops are connected to the signal inputs 51 to 54 of a multiplexer 5. In detail, the data output Q of the first flipflop 3 is connected to the first signal input 51, the data output Q of the second flipflop 3 is connected to the second signal input 52, the data output \overline{Q} of the first flipflop 2 is connected to the signal input 53 and, finally, the data output \overline{Q} of the second flipflop 3 is connected to the signal input 54. The multiplexer 5 is designed such that it successively and cyclically connects the signal inputs 51, 52, 53 and 54 to its data output 11. Furthermore, the data output 11 also forms the signal output of the frequency divider circuit. The cyclic switching process between the individual signal inputs 51 to 54 of the multiplexer 5 to its signal output 11 takes place via a signal at its control input 12. The control input 12 is supplied with a clock signal at a predetermined frequency.

In consequence, with each clock cycle, the multiplexer 5 connects one of its signal inputs to the signal output. The frequency of the clock signal at the control input 12 accordingly results in periodic and cyclic switching in the phase of the signal at the output 11. The periodic switching corresponds to phase modulation or frequency modulation, with the frequency switching being governed by the duration of the periodic switching process.

If, for example, a clock signal CLK at the frequency 1600 MHz is applied to the clock input 10 of the frequency divider circuit, a frequency-divided signal at 800 MHz is emitted at the data outputs of the flipflops 2 and 3. There is a phase offset of 90° between the signals that are emitted. If the input signals are now connected periodically to the signal output at a frequency of, for example, 8 MHz by means of the control signal at the control input 12 in the multiplexer, this results in the frequency of the output signal being 798 or 802 MHz, depending on the switching direction.

Any other design values are possible. The expression switching direction means that rotation direction of a phase vector or the mathematical sign of the time derivative of the phase.

FIG. 2 shows one illustrated embodiment of the frequency divider circuit. Components which have the same effect and/or function have the same reference symbols. In this embodiment, the frequency of the clock signal CLK at the input 10 is divided by a factor of 4, and a total of eight signal elements are produced, which have a frequency offset of 45° or a multiple of 45°.

Two flipflop circuits 64 and 61 are provided for a first frequency divider with a division factor of 2. Their clock signal inputs are connected to the input 10 of the frequency divider circuit 1a. The data output Q of the flipflop circuit 64 is connected to the data input D of the flipflop circuit 61. The data output Q of the flipflop circuit 61 is fed back via an inverter 63 to the data input D of the front-end flipflop circuit 60. In this exemplary embodiment, the flipflop circuits 64 and 61 do not need the additional data output \overline{Q} of the inverted output signal.

Two pairs of two flipflops (2 and 3, and 2a and 3a) are in each case provided in order to produce the signals which have been phase-shifted through 45°. The flipflops in each pair are connected in the same way as the flipflops 2 and 3 in the frequency divider circuit 1 according to the exemplary embodiment shown in FIG. 1. However, the flipflops 2 and 3 are supplied at their clock signal inputs with a clock signal which is derived from the signal at the data output Q of the flipflop circuit 60. This in each case results in signals at one quarter of the input frequency of the clock signal CLK and with a phase offset of 90° with-respect to one another being produced at the outputs Q and \overline{Q} of the two flipflops 2 and 3.

Furthermore, the clock signal input Clk of the flipflop 2a is supplied with the signal from the data output Q of the intermediate flipflop circuit 61. The data output Q of the second flipflop 61 is also connected via an inverter 63 to the clock input Clk of the second flipflop 3a in the second pair. Since, as indicated, the signal at the data output Q of the intermediate flipflop circuit 61 has a phase offset of 90° with respect to the signal at the data output Q of the flipflop circuit 64, this results in signals with the respectively stated phase offsets of 45°, 135°, 225° and 315° at the data outputs Q and Q of the two flipflops 2a and 3a. The outputs Q and \overline{Q} of the flipflop circuits 2, 3, 2a and 3a are once again connected to the signal inputs of a multiplexer 5. The control input 12 of the multiplexer 5 is connected to the output of a frequency divider circuit 60, to whose input the clock signal CLK can be supplied from the signal input 10 of the frequency divider circuit la.

The frequency divider 60 divides the signal that is applied to its input side by the factor N, and passes this to the set input 12 of the multiplexer 5, which once again connects the individual signal inputs cyclically to the signal output at the frequency of the set signal at the set input 12. The division ratio of the frequency divider 60 can be varied via an appropriate signal at the input 121, so that the frequency offset of the output signal at the output 11 can be varied by means of the frequency setting of the frequency divider 60.

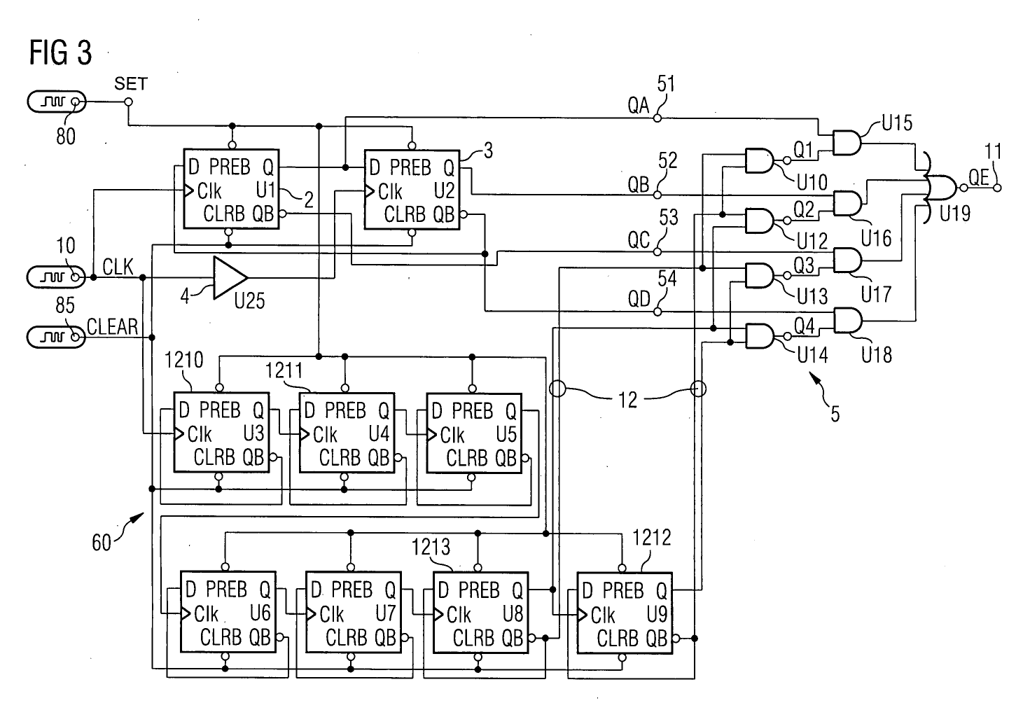

FIG. 3 shows another embodiment, in particular with an implementation of the multiplexer 5 and of the frequency divider circuit 60. Identical components have the same reference symbols in this case as well. The illustrated frequency divider circuit divides the signal CLK that is applied to its input side by a factor of 2, and produces four frequency-divided signal elements QA, QB, QC and QD, each having a phase offset of 90° with respect to one another. The flipflop circuits illustrated here can be switched to a predefined state by means of an additional control signal at the input 80. They can be switched back to the original state again, by means of a second control signal at the input 85. The frequency divider circuit 60 comprises a plurality of series-connected flipflop circuits 1210, 1211, 1212, and 1213.

In the case of the flipflops in the frequency divider circuit 60, the data output QB is connected to the respective data input of the flipflop. Furthermore, each data output Q is connected to a clock input Clk of the following flipflop. The clock signal input Clk of the first flipflop 1210 is connected to the signal input 10. The seven flipflops as illustrated in the frequency divider circuit 60 in this case divide the clock signal CLK at the signal input 10 by the factor 128. On the output side, they emit this at the set output 12 of the mulitplexer unit 5.

Inter alia, the multiplexer unit 5 contains a plurality of logic AND gates U10, U12, U13 and U14, which are arranged in parallel and further process the signal that is emitted from the frequency divider circuit. The two inputs of the first logic AND gate U10 are connected to the data outputs QB of the flipflops 1212 and 1213. In a corresponding manner, the inputs of the gate U14 are connected to the data inputs Q of the logic gates 1212 and 1213. The inputs of the logic AND gate U12 are connected to the data output QB of the flipflop 1212, and to the input Q of the flipflop 1213. Finally, a first input of the gate U13 is coupled to the data output QB of the flipflop 1213, and a second input of the gate U13 is coupled to the data output Q of the flipflop 1212. The logic AND gates U10, U12, U13 and U14 produce control signals which connect the respective signals applied to the signal inputs 51, 52, 53 and 54 to the output 11 by means of the logic AND gates U15 to U18.

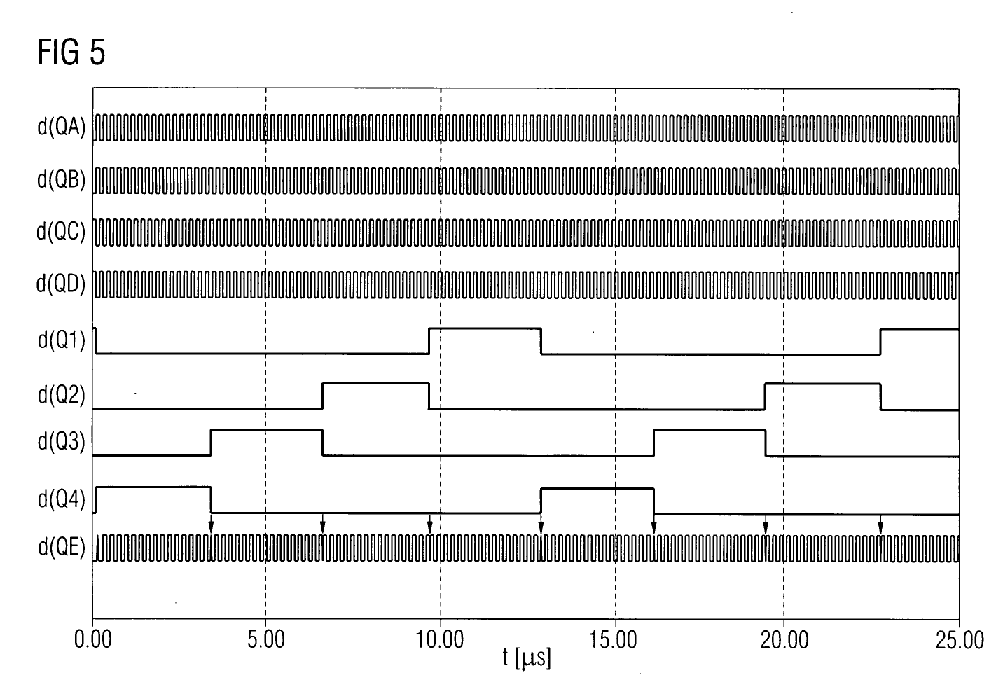

FIG. 5 shows a selection of different signals over time. This clearly shows the different phase angle in the signals QA, QB, QC and QD. As can be seen, the control signals Q1 to Q4 connect the signals QA to QD which are applied on the input side to the output QE or 11 at different times. This clearly shows the sudden phase change at the respective switching times. This periodic sudden phase change produces the frequency modulation in the output signal.

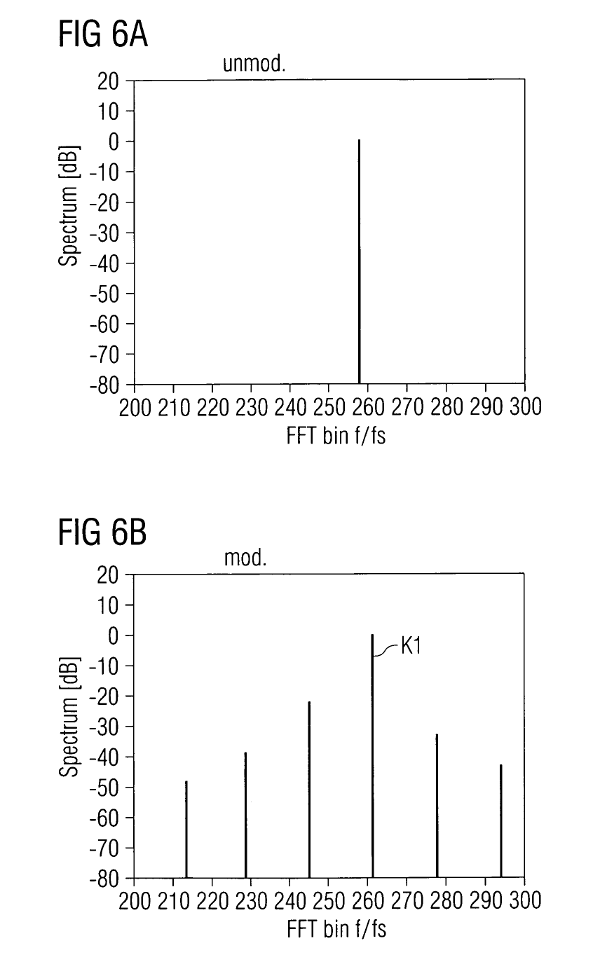

FIG. 6 shows one associated frequency spectrum. FIG. 6A shows a single signal, which represents an unmodulated carrier signal. The signal element is at a well-defined frequency, which results from the division factor and the frequency of the signal supplied on the input side. In contrast, FIG. 6B shows the modulated signal, to which a frequency offset has been applied. The further spectral components whose power level is considerably reduced in comparison to that of the main component K1, are produced by the digital signal processing. Because of the low-pass filter characteristic of the demodulator within the reception path, these are easily suppressed and can be ignored in a subsequent loop-back test. As can also be seen, there is no spectral component of the unmodulated carrier signal in the output signal from the modulated carrier in FIG. 6B.

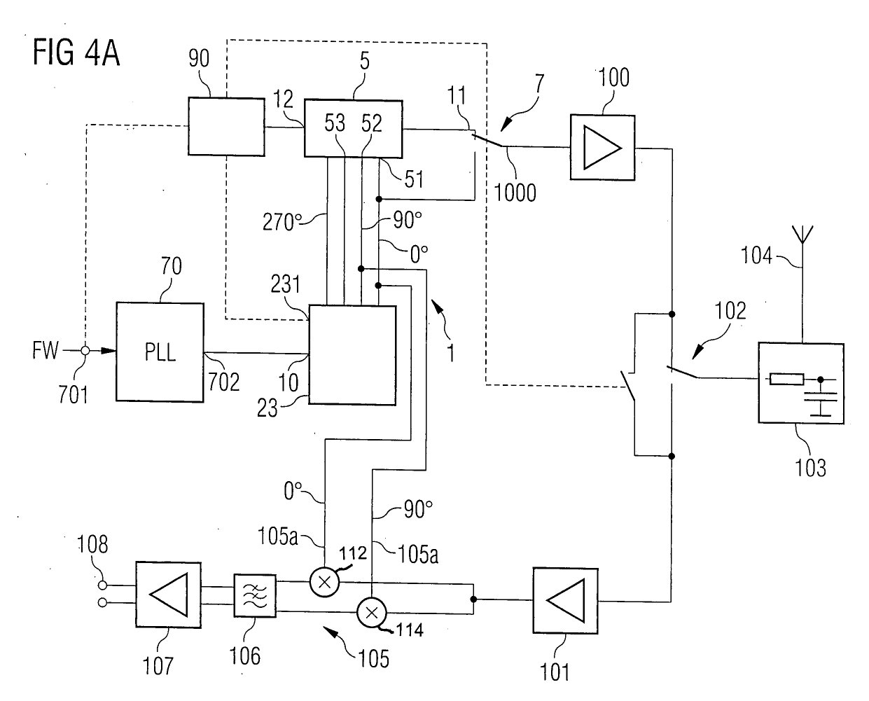

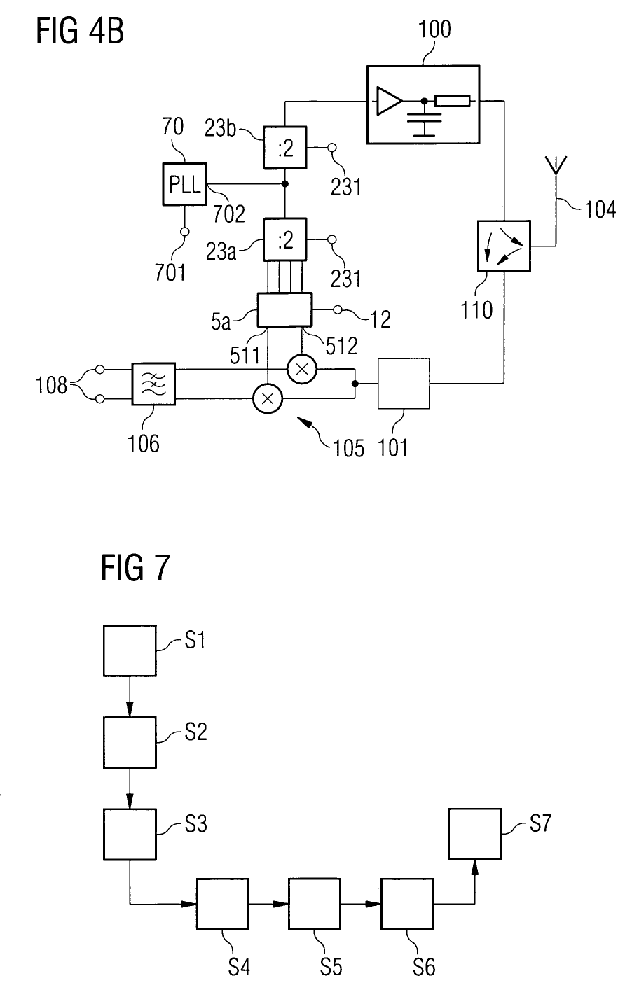

FIG. 4A shows one transmitter/receiver that includes one embodiment of the controllable frequency divider circuit. Components which have the same effect and/or function have the same reference symbols. The transmitter/receiver that is illustrated here is formed at least partially in a semiconductor body as an integrated circuit. It contains a phase locked loop 70 to whose control input 701 a frequency word can be supplied, in order to set the frequency of the output signal from the phase locked loop. This frequency word FW is also used for phase or frequency modulation of the output signal when the transmitter/receiver is in the transmission mode. Thus, in this embodiment, no additional modulator is required for the transmission path, and, instead, the data to be transmitted is modulated directly into the phase of the carrier signal. On the output side, the phase locked loop 70 is connected to the input 10 of the frequency divider circuit 23. The circuit 23 comprises the various flipflops for frequency division. The circuit 23 has a set input 231 for supplying a set signal. The set signal is used to set a frequency division ratio for the circuit 23. This makes it possible to produce output signals at different frequencies.

In various embodiments, it is possible to switch between the transmission frequency and the reception frequency in an efficient manner by variation of the frequency division ratio in the circuit 23. As shown in FIG. 4, a frequency-divided signal is accordingly produced at the outputs of the frequency divider circuit 23, depending on the division ratio produced by the signal at the set input 231. The signals which can be tapped off on the output side each have a phase offset of 90° or a multiple of 90° with respect to one another. For example, three of the signals are phase-shifted through 90°, 180° and 270° with respect to a fourth. The outputs of the frequency divider circuit 23 are connected to the signal inputs of the multiplexer circuit 5. The set input 12 of the multiplexer circuit 5 is coupled to a control circuit 90.

Furthermore, a switching apparatus 7 is provided, which has two inputs and one output and is designed for selective coupling of one of the two inputs to its output. One of the two inputs is connected to the signal output 11 of the multiplexer 5. The second input is connected to the signal input 51 of the multiplexer 5, and to the corresponding output of the frequency divider circuit 23. Depending on the operating mode, the switch 7 will be in the first or the second switch position. In a normal transmission operating mode, the switch 7 is connected directly to the output of the frequency divider 23. The signal, which has been phase-modulated by the phase locked loop 70 on the basis of the data to be transmitted, is divided by the frequency divider circuit 23, and is emitted at its outputs. The frequency-divided and phase-modulated signal is supplied via the switch 7 to an amplifier 100, and is then passed to an antenna 104 via a second switch 102 and a matching network 103. The second switch 102 is monitored by the control device 90 in the same way as the switch 7.

A first low-noise amplifier 101 is provided in the reception path, and its input side is likewise connected to the switch 102. On the output side, the low-noise amplifier 101 is connected to an I/Q demodulator 105 which, as indicated here, comprises two mixers 112, 114. A signal with a phase offset of 90° can be supplied to each of the two local oscillator inputs 105a of the mixers in the I/Q demodulator. This signal is preferably likewise produced by the frequency divider circuit 23.

The output of the I/Q demodulator 105 is connected to a low-pass filter 106, whose outputs are connected to an amplifier 107. The frequency-converted signal which has been broken down into its two components can be tapped off at the connections 108 of the reception path.

For a transmission mode, the input 701 of the phase locked loop is supplied with the frequency setting word for phase modulation. At the same time, the control circuit 90 sets the frequency divider 23 in an appropriate manner, switches the switch 7 to the second switch position for connection of the output of the frequency divider to the input of the amplifier 100, and connects the output of the amplifier 100 to the transmitting antenna 104.

For the normal reception mode, the phase locked loop 70 produces a constant carrier signal, which is divided by the frequency divider circuit 23 in accordance with the division ratio setting. The two frequency-divided signals, which are phase-shifted through 90°, are supplied to the I/Q demodulator 105 as local oscillator signals to the local oscillator input 105a. A signal which is received from the antenna 104 is applied to the input of the low-noise amplifier 101, is amplified by it, and is broken down into its in-phase component I and its quadrature component Q by means of the two local oscillator signals and the I/Q demodulator. The received signal is then low-pass-filtered, amplified and passed on to the output taps 108 for further signal processing.

For a loop-back test, the control device 90 switches the switch 7 to the first switch position, and thus connects the output 11 of the multiplexer 5 to the input of the amplifier 100 in the transmission path. At the same time, the switch 102 for the antenna is moved to a mid-position, and the transmission path is connected directly to the reception path. The phase locked loop 70 then produces a carrier signal at a constant frequency, and supplies this to the frequency divider 23, which divides the signal supplied to it and uses it to produce four signal elements, which each have a phase offset of 90°, or a multiple of 90°. The signal elements are supplied to the signal inputs 51 to 54 of the multiplexer 5. At its output 11, the multiplexer 5 emits the respective signal elements, in a cyclic sequence. The clock period is in this case supplied by a set signal to the control circuit 90, at its input 12. The frequency offset produced in this way is processed in the rest of the transmission path, and is applied to the reception amplifier 101.

At the same time, the frequency divider circuit 23 produces two signal elements as local oscillator signals. The signal which is fed back from the transmission path into the reception path is converted in the I/Q demodulator 105, and results in a signal at a difference frequency, whose amplitude and phase are measured at the output taps 108, and are evaluated.

In various embodiments, one advantage of the transmitter/receiver is that there is no need to provide any further frequency preprocessing on the semiconductor chip. In the embodiment illustrated in FIG. 4A, a frequency offset is produced in the transmission signal. However, it is also possible to provide a corresponding frequency offset by cyclic progression in the local oscillator signal in the reception path, and to use a test signal at a constant carrier frequency in the transmission path. One such embodiment is shown in FIG. 4B.

Components having the same effect and/or function also have the same reference symbols in this case as well. In this illustrated embodiment, two frequency dividers 23a and 23b are provided, whose frequency division ratio can be controlled via a respective set signal at a set input 231. The frequency divider 23a for the reception path is also designed to produce phase-shifted signals. The outputs of the frequency divider 23a are connected via a multiplexer 5 to the local oscillator inputs of the I/Q demodulator 105.

The illustrated multiplexer 5a can assume a first operating mode by emitting on its output side two signal elements which have a phase offset of 90°. In this embodiment, the reception path for the reception of signals is passed via the antenna 104 and the switching apparatus 110. In a second operating mode, the multiplexer 5a emits a frequency-offset signal at its two outputs 511 and 512. This frequency-offset signal is produced by the multiplexer 5a cyclically connecting its respective inputs to the two outputs. The frequency offset of 90° between the signal elements and the two outputs 511 and 512 is maintained.

FIG. 7 shows an exemplary embodiment of the method for carrying out a loop-back test. In step S1, a transmission path and a reception path are provided with a frequency converter. The frequency converter in the reception path is designed to supply a local oscillator signal for frequency conversion. The transmission path is coupled to the reception path.

In step S2, a carrier signal is then produced at one frequency. The frequency of the carrier signal is preferably constant, that is to say it is not phase or frequency-modulated. In step S3, the frequency of the carrier signal is divided, and at least three signal elements are produced at this divided frequency, and in each case with a different phase. Four signal elements are preferably produced with a phase offset of 90°, or a multiple of 90°. In step S4, two of these four signal elements with a phase offset of 90° are used as a local oscillator signal.

A clock signal at a second frequency is then provided in step S5. The first, second, third or fourth signal element is now selected cyclically, and is applied to the transmission path. In this case, one new signal element is applied to the transmission path in each clock period of the clock signal. For example, the transmission path is supplied with the first clock signal during the first clock period, with the second clock signal during the second clock period, etc. Alternatively, the transmission path can also be supplied with the fourth signal element in the first clock period, and with the third signal element in a second clock period following the first, etc. The cyclic application of the four signal elements to the transmission path leads to a frequency offset, with the offset corresponding to the frequency of the clock signal that is used to carry out the cyclic selection process.

In other embodiments, the frequency offset is provided in the local oscillator signal rather than in the transmission path by cyclic selection of the signal elements and subsequently supplying them to the transmission path. For this purpose, the signal elements are applied cyclically to the reception path in the same way, as local oscillator signals. In step S6, the signal which is emitted from the transmission path is fed back to the reception path. The frequency of the signal which has been emitted from the transmission path and has been fed back is converted by means of the local oscillator signal in the reception path. The frequency offset in the transmission path results in a signal at the difference frequency between the local oscillator signal and the signal which is emitted from the transmission path. The amplitude and the phase angle of this difference signal are then determined, in step S7.

The illustrated loop-back test can be used, for example to detect amplifiers, mixers or other components within the transmission path and/or reception path which have been damaged during production. A loop-back test by means of which simple functionalities of a transmitter/receiver can be checked can thus be implemented without any major additional complexity, and in particular without additional frequency preprocessing circuits. Undesirable components which are produced during the frequency modulation as a result of the periodical switching process can be suppressed in a simple manner by means of additional low-pass or bandpass filters at the output of the multiplexer 5.

Although the invention has been shown and described with respect to a certain aspect or various aspects, equivalent alterations and modifications will occur to others skilled in the art upon the reading and understanding of this specification and the annexed drawings. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. Furthermore, the methods of the present invention may be implemented in association with various types of components and systems, and any such system or group of components, either hardware and/or software, incorporating such a method is contemplated as falling within the scope of the present invention. In addition, while a particular feature of the invention may have been disclosed with respect to only one of several aspects of the invention, such feature may be combined with one or more other features of the other aspects as may be desired and advantageous for any given or particular application. Furthermore, to the extent that the term “includes” is used in either the detailed description or the claims, such term is intended to be inclusive in a manner similar to the term “comprising.”

### LIST OF REFERENCE SYMBOLS

1,1a: Controllable frequency divider circuit
2,3: Flipflop circuit
2a,3a: Flipflop circuit
4: Inverter
5: Multiplexer
7: Switch
10: Clock signal input
11: Signal output
12: Control input
23: Frequency divider
51,52,53,54: Signal inputs
55,56,57,58: Signal inputs
60: Variable frequency divider
61,64: Flipflops
62,63: Inverter
70: Phase locked loop
90: Control circuit
100: Transmission amplifier
101: Low-noise amplifier
102: Switch
103: Matching network
104: Antenna
105: Frequency converter, I/Q demodulator
105a: Local oscillator input
106: Low-pass filter
107: Amplifier
108: Output taps
231: Set input
701: Set input
702: Signal output
511,512: Signal outputs
Clk: Clock signal input
D: Data input
Q: Data output
\overline{Q}: Data output for inverted output signal
CLK: Clock signal
S1, . . . , S7: Method steps

1. A controllable frequency divider circuit, comprising:
a signal input for supplying a clock signal;
a signal output;
a front-end flipflop circuit with a clock input that is coupled to the signal input, with a data input, with an un-inverted data output, and with a inverted data output;
at least one intermediate flipflop circuit with a clock input that is coupled to the signal input, with a data input that is connected to the un-inverted data output of the front-end flipflop, with an un-inverted data output, and with an inverted data output that is coupled to the data input of the front-end flipflop circuit forming a feedback path;
a multiplexer with a first signal input that is connected to the un-inverted data output of the front-end flipflop circuit, with a second signal input that is coupled to the un-inverted data output of the intermediate flipflop circuit, with a third signal input that is coupled to the inverted data output of the front-end flipflop circuit, and with a fourth signal input that is coupled to the inverted data output of the intermediate flipflop circuit, with a multiplexer data output, and with a multiplexer control input, and with the multiplexer being designed to periodically controllably pass one of the first, second, third, or fourth signal inputs to the multiplexer data output as a function of a frequency of a control signal that is supplied to the multiplexer control input.

2. The controllable frequency divider circuit as claimed in claim 1, in which the clock input of the intermediate flipflop circuit is connected to the output of an inverter having an input side that is coupled to the signal input.

3. The controllable frequency divider circuit as claimed in claim 1, in which the controllable frequency divider circuit has an additional frequency divider with an output side that is connected to the multiplexer control input, and with an input side that is connected to the signal input of the frequency divider circuit.

4. The controllable frequency divider circuit as claimed in claim 3, in which the additional frequency divider has a set input for setting the division ratio of the additional frequency divider.

5. The controllable frequency divider circuit as claimed in claim 3, in which the additional frequency divider comprises two series-connected flipflop circuits, each of whose non-inverted data outputs are connected to the multiplexer control input, and each of whose inverted data outputs are connected to respective data inputs of the two series-connected flipflop circuits and to the multiplexer control input.

6. The controllable frequency divider circuit as claimed in claim 1, in which the multiplexer comprises a logic OR gate with an OR-output and an OR-input, wherein the OR-output forms the multiplexer output and wherein the OR-input is connected to an AND-output of at least one logic AND gate, with a AND-input of the at least one logic AND gate being coupled to one of the first, second, third or fourth signal inputs of the multiplexer, and with a second AND-input of the at least one logic AND gate being coupled to the multiplexer control input.

7. The frequency divider circuit as claimed in claim 1, further comprising:
a transmission path with an input and an amplifier circuit;
a reception path with an amplifier circuit, with a frequency converter for frequency conversion, which is connected to the amplifier circuit and has a local oscillator input as well as an output;
a phase locked loop with an output for a carrier signal, which output is connected to the signal input of the controllable frequency divider circuit;
a switch with a first input, with a second input, and with an output; wherein the switch is designed for selective coupling of one input to its output, with the first input of the switch being coupled to the signal output of the controllable frequency divider circuit, and with the second input of the switch being coupled to the output of the phase locked loop;
wherein the output of the switch is coupled to the input of the transmission path or to the local oscillator input of the frequency converter.

8. The transmitter/receiver as claimed in claim 7, in which the local oscillator input of the frequency converter is coupled in the reception path to the output of the phase locked loop.

9. The transmitter/receiver as claimed in claim 7, in which the frequency converter is in the form of an I/Q demodulator with a first mixer and with a second mixer.

10. The transmitter/receiver as claimed in claim 7, in which a frequency divider is arranged between the output of the phase locked loop and forms a part of the frequency divider circuit, and the outputs of the frequency divider are connected to the inputs of the multiplexer.

11. The transmitter/receiver as claimed in claim 10, in which at least one output of the frequency divider is coupled to the second input of the switch.

12. A method for carrying out a loop-back test, comprising the following steps:
provision of a transmission path;
provision of a reception path with a frequency divider to which a local oscillator signal can be supplied;
coupling of the transmission path to the reception path;
production of a carrier signal at one frequency;
division of the frequency of the carrier signal and production of at least four signal elements at the divided frequency and each with a different phase;
periodical selection of one of the at least four signal elements;
supply of the respectively selected signal to the transmission path and of a signal at the frequency of the at least four signal elements as a local oscillator signal to the reception path, or supply of a signal at the frequency of the at least four signal elements to the transmission path, and of the respectively selected signal as a local oscillator signal to the reception path;
feedback of the signal emitted from the transmission path to the reception path;
frequency-conversion of the signal emitted from the transmission path using the local oscillator signal; and
determination of the amplitude of the frequency-converted signal.

13. The method as claimed in claim 12, in which, in the step of production of the at least four signal elements, the signal elements have a phase offset from one another of 90°, or a multiple of 90°.

14. The method as claimed in claim 12, in which, in the step of supplying a signal at the divided frequency, the signal is formed by one of the at least four signal elements.

15. The method as claimed claim 13 in which the step of division of the carrier signal comprises the following step:
division of the carrier signal and production of the signal at the frequency of the at least four signal elements.

16. The method as claimed in one of claim 13, in which the step of periodic selection comprises the following steps:
provision of a clock signal;
cyclic selection of the first, second, third or fourth signal element as a function of a frequency which is derived from the clock signal.

17. A method for providing a divided frequency comprising the following steps:
providing a clock signal;
producing a plurality of signals at one frequency, each of the signals having a different phase with respect to each of the other signals;
selecting a first and a second of the plurality of signals and providing a phase change at a respective switching time of the first and second signals.

18. The method of claim 17, further comprising:
cyclically selecting at least two of the plurality of signals and providing a phase change at a the associated switching time.

19. The method of claim 18, further comprising:
supplying the selected signal to both a transmission path and a reception path; and
feeding back a signal emitted from the transmission path to the reception path.

20. The method of claim 19, further comprising:
converting the frequency of the signal emitted from the transmission path; and
determining the amplitude of the frequency-converted signal.
